(19) United States
(12) Patent Application Publication
(10) Pub. No.: US 2023/0384714 A1
(43) Pub. Date: Nov. 30, 2023

(54) EXHAUST HOOD

(71) Applicant: Hewlett-Packard Development Company, L.P., Spring, TX (US)

(72) Inventors: Peter Nedelin, Nes Ziona (IL); Mark Sandler, Nes Ziona (IL)

(21) Appl. No.: 17/824,739

(22) Filed: May 25, 2022

(51) Int. Cl. G03G 15/11

(52) U.S. Cl. CPC G03G 15/11

(57) ABSTRACT

In one example, an exhaust hood includes an enclosure having a perimeter defining an exhaust area and a fluid flow path. The fluid flow path includes a perimeter intake slot through which air is sucked into the flow path during an exhaust operation and a flow channel in fluid communication with the perimeter intake slot and configured to carry fluid away from the intake slot and out of the enclosure.

### BACKGROUND

Ink used in liquid electro-photographic (LEP) printing contains tiny pigments encapsulated in a polymer resin, forming polymer particles that are dispersed in a carrier liquid. The polymer particles are sometimes referred to as toner particles and, accordingly, LEP ink is sometimes called liquid toner. In one type of LEP printing process, an electrostatic pattern of the desired printed image is formed on a photoconductor for each color of the image. Each color is developed by applying a thin layer of LEP ink to the photoconductor. Charged polymer particles in the ink adhere to the electrostatic pattern on the photoconductor to form the desired pattern of liquid ink for that color. Each color pattern is commonly referred to as a “separation.” Each liquid ink color separation is transferred from the photoconductor to an intermediate transfer member and heated to evaporate the carrier liquid and melt the polymer particles into a smooth film. The film is transferred from the intermediate transfer member to the print substrate by direct contact.

### DRAWINGS

FIG. 1 is an elevation view showing one example of an exhaust system over a work surface.

FIG. 2 is a bottom plan view looking up at the example exhaust system shown in FIG. 1.

FIG. 3 is an elevation view showing another example of an exhaust system over a work surface.

FIG. 4 is a bottom plan view looking up at the example exhaust system shown in FIG. 3.

FIG. 5 an elevation view illustrating an inline LEP printer implementing one example of an exhaust system to evacuate vapors generated while drying the ink.

FIGS. 6 and 7 are bottom isometric views illustrating an example exhaust hood such as might be used in the printer shown in FIG. 5, with the exhaust hood partially exploded in FIG. 7.

FIGS. 8 and 9 are top isometric views of the example exhaust hood shown in FIGS. 6 and 7, with the exhaust hood partially exploded in FIG. 9.

FIG. 10 is a top plan view of the interior of the example exhaust hood shown in FIGS. 6-9, showing one example for the layout of the flow channel conduits.

FIG. 11 is a bottom plan view of the example exhaust hood shown in FIGS. 6-9.

The same part numbers refer to the same or similar parts throughout the figures. The figures are not necessarily to scale.

### DESCRIPTION

In some LEP printers, the intermediate transfer member is a belt that rotates in an endless loop past a series of printing units. Each printing unit applies a liquid ink color separation to the surface of the rotating belt one after another to form a liquid ink image on the belt. The belt is heated to dry the liquid ink image to a molten film. The molten film is transferred from the belt to the print substrate at a nip between the belt and a pressure roller. Infrared lamps are commonly used to heat the intermediate transfer belt to dry the ink and to keep the molten film hot to the point of transfer.

Evaporating the carrier liquid to dry the ink generates vapors that include unwanted contaminants, sometimes referred to as “VOCs” (volatile organic compounds). To prevent the release of VOCs and to reclaim carrier liquid, the contaminated air is evacuated to a condenser where the carrier vapor is condensed back to a liquid and removed from the air. The clean air is exhausted to the environment or recirculated inside the printer. Currently in an inline LEP printer, higher suction air flows are used to evacuate the full volume of the exhaust hoods to capture carrier vapors from the comparatively large surface area of the intermediate transfer belt while preventing vapor escaping the hood to the surrounding environment. For example, a total suction air flow of more than 1,000 L/s from four inline exhaust hoods is used to capture carrier vapors from approximately 1 m² of belt surface area in a six color in-line LEP printer. A higher suction air flow means a lower concentration of vapor in the flow. Condensing carrier liquid from an air flow with a lower concentration of vapor is less efficient and therefore more costly compared to condensing carrier liquid from an air flow with a higher concentration of vapor.

A new exhaust system has been developed to enable the use of lower suction air flows to effectively evacuate carrier vapors from the surface of an intermediate transfer belt in an inline LEP printer. Examples of the new system use an exhaust hood with perimeter intake slots connected to a central suction duct. Since the area of the intake slots is much smaller than the total area covered by the hood, carrier vapor may be captured effectively at lower suction (differential pressure) and lower overall suction air flow, while still preventing vapor escaping the hood to the surrounding environment. Lower suction air flow means a higher concentration of carrier vapor in the flow. Condensing carrier liquid from an air flow with a higher concentration of vapor is more efficient and therefore less costly compared to condensing carrier liquid from an air flow with a lower concentration of vapor. Cost savings may justify the added expense of chilling the air to lower temperatures to increase the concentration of vapor in the air flow even more to condense out more VOCs and thus further lower the ppm of VOCs remaining the air discharged to the environment or recirculated in the printer. Examples of the new exhaust hood may also include one or multiple interior intake slots extending across the exhaust area between perimeter intake slots.

Examples are not limited to LEP printing but may be implemented in other printing and/or non-printing applications. The examples shown in the figures and described herein illustrate but do not limit the scope of the patent, which is defined in the Claims following this Description.

As used in this document “and/or” means one or more of the connected things; “LEP ink” means a liquid that includes polymer particles in a carrier liquid suitable for electro-photographic printing; and a “slot” means an opening with a ratio of length to width (L/W) at least 60, where length is the longer dimension of the slot and width is the shorter dimension of the slot.

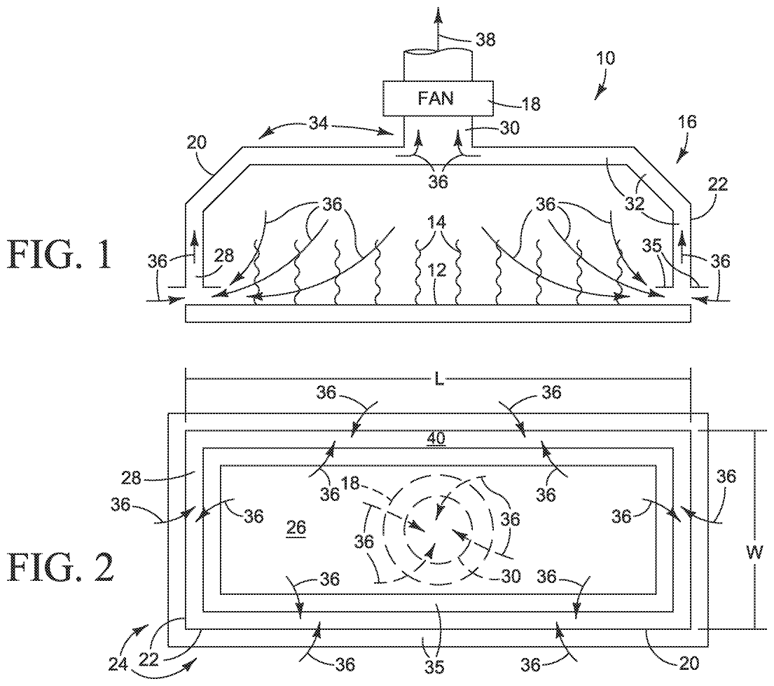

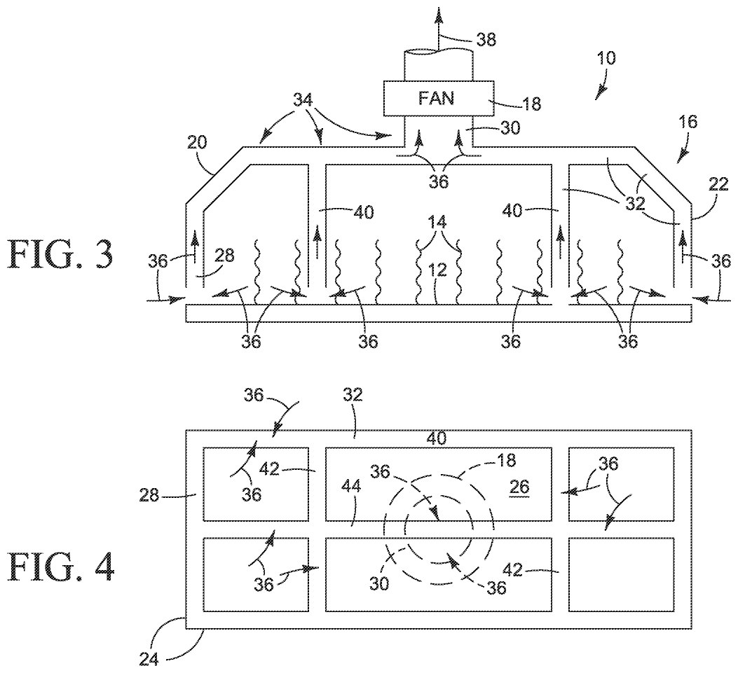

FIG. 1 is an elevation view showing one example of an exhaust system 10 over a work surface 12. Work surface 12 is giving off vapors 14 in FIG. 1. FIG. 2 is a bottom plan view looking up at system 10 in FIG. 1. Surface 12 is omitted from FIG. 2 to more clearly show some of the features of exhaust system 10. Referring to FIGS. 1 and 2, system 10 includes an exhaust hood 16 and a fan 18. Hood 16 includes an enclosure 20 with walls 22 defining a rectangular perimeter 24 surrounding an exhaust area 26. Hood 16 also includes an intake slot 28 along substantially the full perimeter 24 of enclosure 20 such that intake slot 28 surrounds exhaust area 26. “Substantially” the full perimeter of enclosure 20 means enough of the perimeter to suck in air along the full perimeter even though there be gaps in perimeter intake slot 28. The orientation of hood 16 and work surface 12 in FIG. 1 is just one example. Other orientations are possible. For example, hood 16 could be located alongside a vertically oriented work surface 12. For another example, hood 16 could be located under a down facing work surface 12.

Hood 16 in FIGS. 1 and 2 also includes a discharge port 30 and a flow channel 32 between perimeter intake slot 28 and discharge port 30. Perimeter intake slot 28, channel 32, and discharge port 30 together form a fluid flow path 34 through exhaust hood 16. In an exhaust operation, fan 18 sucks air and vapor into slot 28 and through channel 32 to discharge port 30, as indicated by flow arrows 36. The air/vapor fluid can then be exhausted from system 10, as indicated by exhaust arrow 38, for example to vapor removal. In this example, flow channel 32 is integral to enclosure walls 22. Also in this example, perimeter intake slot 28 is surrounded on both sides by a flange 35 that stiffens walls 22 to help maintain a uniform width along the full length of slot 28.

For a rectangular perimeter 24 in FIGS. 1 and 2, exhaust area 26 is the product of the length L and width W of perimeter 24. Intake slot 28 covers an intake area 40 that is the product of the length and width of slot 28. Although the ratio of intake area 40 to exhaust area 26 to achieve the desired flow characteristics will vary depending on the volume of enclosure 20, the amount of vapor 14, the configuration of flow path 34, and the volume and the operating characteristics of fan 18, testing and flow simulation show an intake area 40 less than 10% of exhaust area 26 will be adequate in many LEP printing applications to effectively evacuate enclosure 20 while developing a sufficient pressure difference at slot 28 to prevent any significant amount of vapor 14 from escaping enclosure 20.

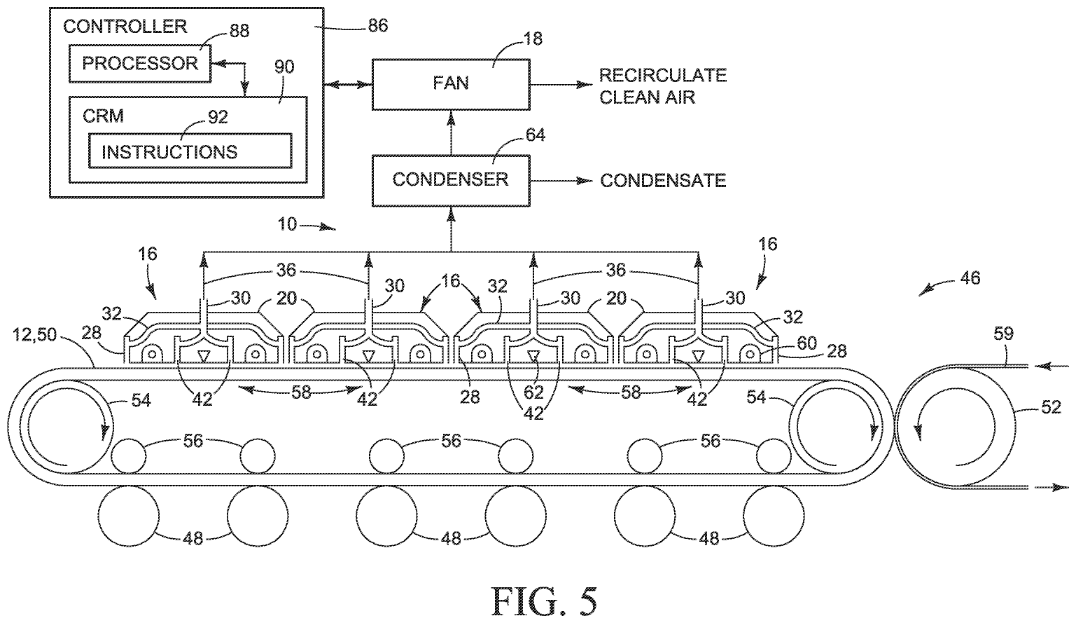

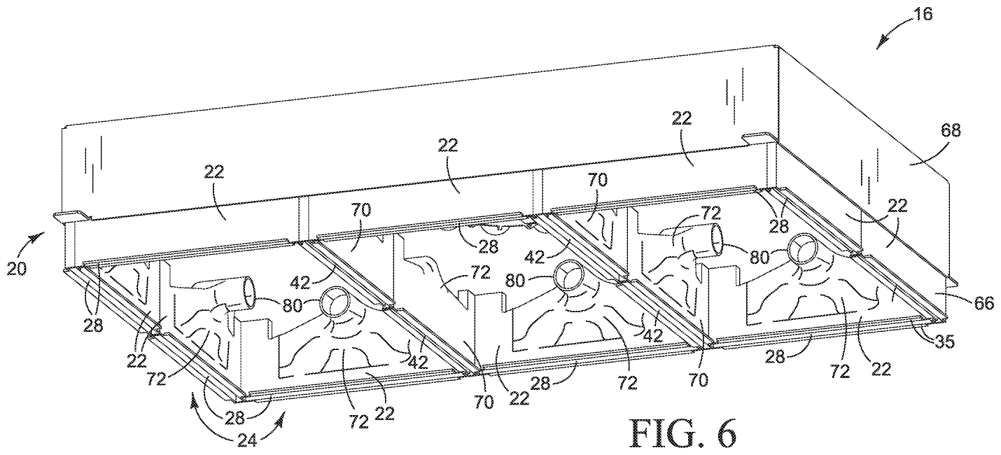

FIG. 3 is an elevation view showing another example of an exhaust system 10 over a work surface 12. Work surface 12 is giving off vapors 14 in FIG. 3. FIG. 4 is a bottom plan view looking up at system 10 in FIG. 3. Surface 12 is omitted from FIG. 4 to more clearly show some of the features of exhaust system 10. Referring to FIGS. 3 and 4, system 10 includes an exhaust hood 16 and a fan 18. Hood 16 includes an enclosure 20 with walls 22 defining a rectangular perimeter 24 surrounding an exhaust area 26. Hood 16 also includes a perimeter intake slot 28 along substantially the full perimeter of enclosure 20 such that perimeter intake slot 28 surrounds exhaust area 26. In this example, hood 16 also includes crosswise interior intake slots 42 and a lengthwise interior intake slot 44. Interior intake slots such as slots 42, 44 in FIGS. 3 and 4 may be desirable, for example, to effectively evacuate a larger volume enclosure 20 and/or greater amounts of vapor 14.

Hood 16 in FIGS. 3 and 4 also includes a discharge port 30 and a flow channel 32 between intake slots 28, 42, 44 and discharge port 30. Intake slots 28, 42, 44, channel 32, and discharge port 30 together form a fluid flow path 34 through exhaust hood 16. In an exhaust operation, fan 18 sucks air and vapor into slots 28, 42, 44 and through channel 32 to discharge port 30, as indicated by flow arrows 36. The air/vapor fluid can then be exhausted from system 10, as indicated by exhaust arrow 38, for example to vapor removal.

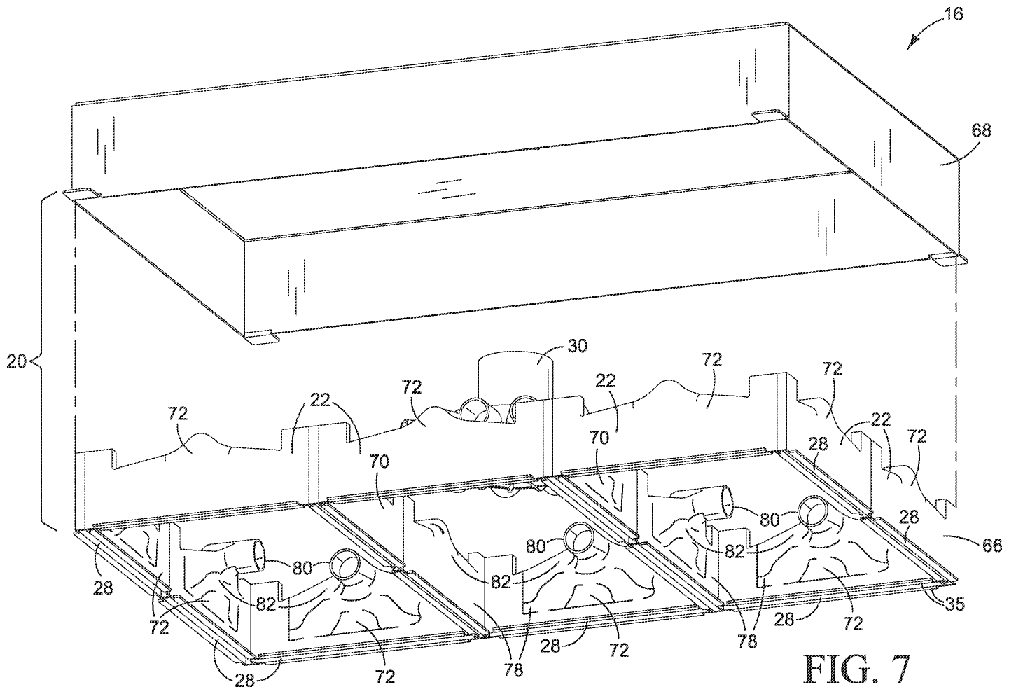

FIG. 5 an elevation view illustrating an inline LEP printer 46 implementing one example of an exhaust system 10 to evacuate vapors generated while drying the ink. Referring to FIG. 5, printer 46 includes multiple LEP printing units 48, an intermediate transfer belt 50, and a pressure roller 52. Although six printing units 48 are shown for six color separations, more or fewer printing units 48 could be used for more or fewer color separations. Belt 50 rotates in a loop around rollers 54 past printing units 48 and pressure roller 52. Each printing unit 48 applies an LEP ink color separation to the rotating belt 50. The color separations are gathered together on belt 50 as a full color ink image.

Although not shown in FIG. 5, an LEP printing unit 48 usually includes a photoconductor, a scanning laser or other suitable photo imaging device, and a developer. The laser exposes select areas on photoconductor to light to form a charge pattern on the photoconductor corresponding to the respective color separation. The developer applies a thin layer of LEP ink to the patterned photoconductor. Ink from the developer adheres to the charge pattern on the photoconductor to develop a color separation on the photoconductor. Each liquid ink color separation is transferred from the photoconductor to intermediate transfer belt 50. An idler roller 56 opposite each printing unit 48 helps keep belt 50 properly positioned with respect to the corresponding photoconductor.

The color separations on belt 50 are dried to a molten film by a series of dryers 58. The pressure roller 52 presses a paper or other printable substrate 59 against the rotating belt 50 to transfer the molten film from the belt to the substrate 59. In the example shown in FIG. 5, each dryer 58 includes two IR lamps or other suitable heaters 60, an air knife 62, and an exhaust hood 16 to contain and evacuate vapors produced while drying the ink on belt 50. Each hood 16 includes an enclosure 20 with a perimeter intake slot 28 along substantially the full perimeter of enclosure 20 and crosswise interior intake slots 42. Each hood 16 also includes a discharge port 30 and a flow channel 32 between intake slots 28, 42 and discharge port 30. Exhaust hoods 16 are part of an exhaust system 10 that includes a condenser 64 and a fan 18. (Belt 50 is the work surface 12 for exhaust system 10.) In operation, fan 18 sucks air and vapor into slots 28, 42, along channel 32 to discharge port 30 and through condenser 64 where the vapor is removed from the air and the condensate recycled or discarded. The clean air is recirculated inside the printer or discharged to the environment.

Printer 46 in FIG. 5 also includes a controller 86 with the programming, processing and associated memory resources, and the other electronic circuitry and components to control fan 18. In the example shown in FIG. 5, controller 86 includes a processor 88 and a computer readable medium 90 with control instructions 92 operatively connected to processor 88. Control instructions 92 represent programming that, when executed, controls fan 18 to generate the desired flow characteristics for exhaust system 10 in printer 46. For example, as described in more detail below, controller 86 executing instructions 92 controls fan 18 to generate a pressure difference of 1.0-3.0 Pa at intake slots 28, 42 with a suction flow of 25-100 L/s per square meter (L/s/m²) of the exhaust area. Controller 86 in FIG. 5 may be implemented as a discrete controller dedicated to fan 18, or some or all of the components of controller 86 may be part of a system, print engine and/or printer controller.

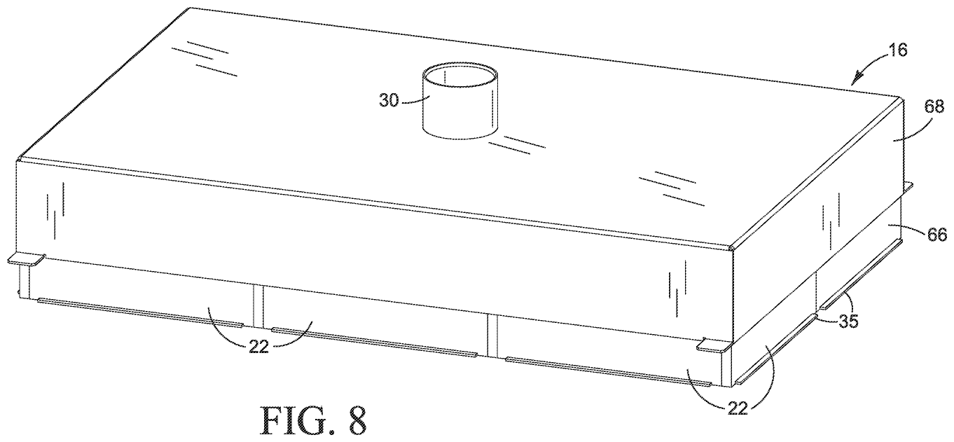

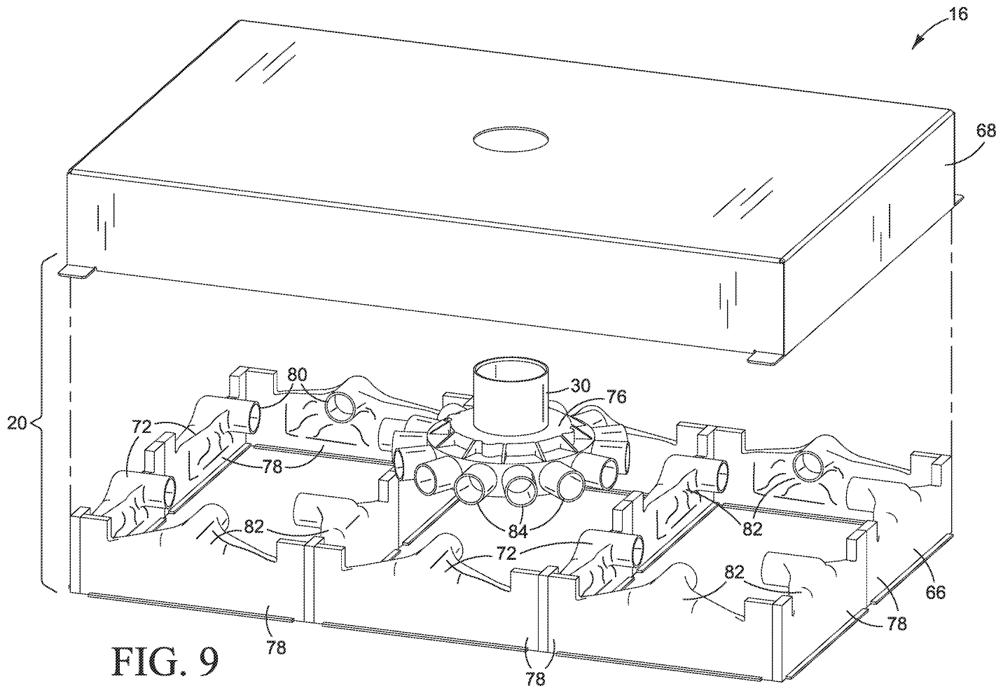

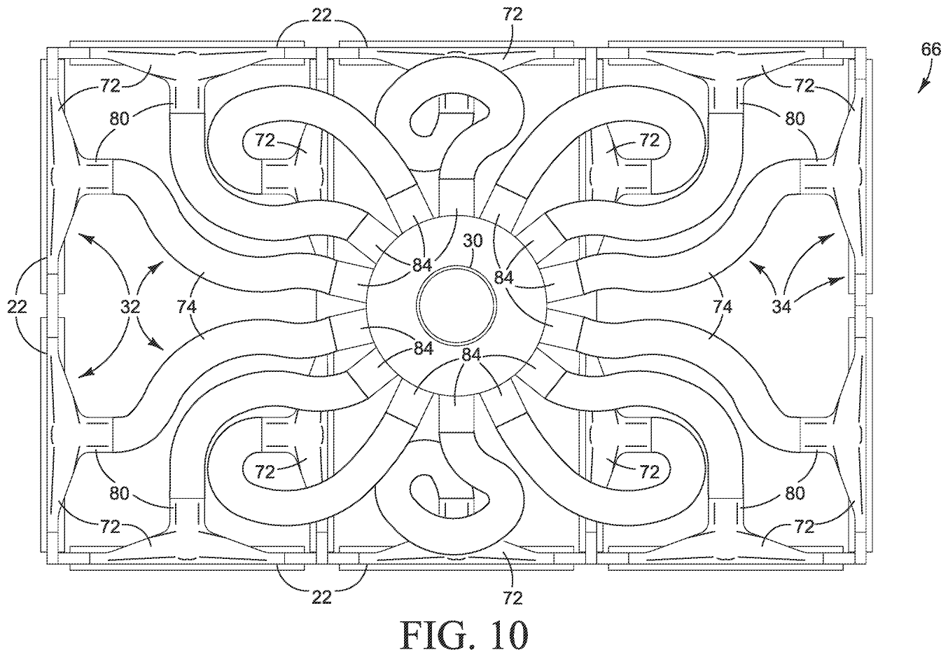

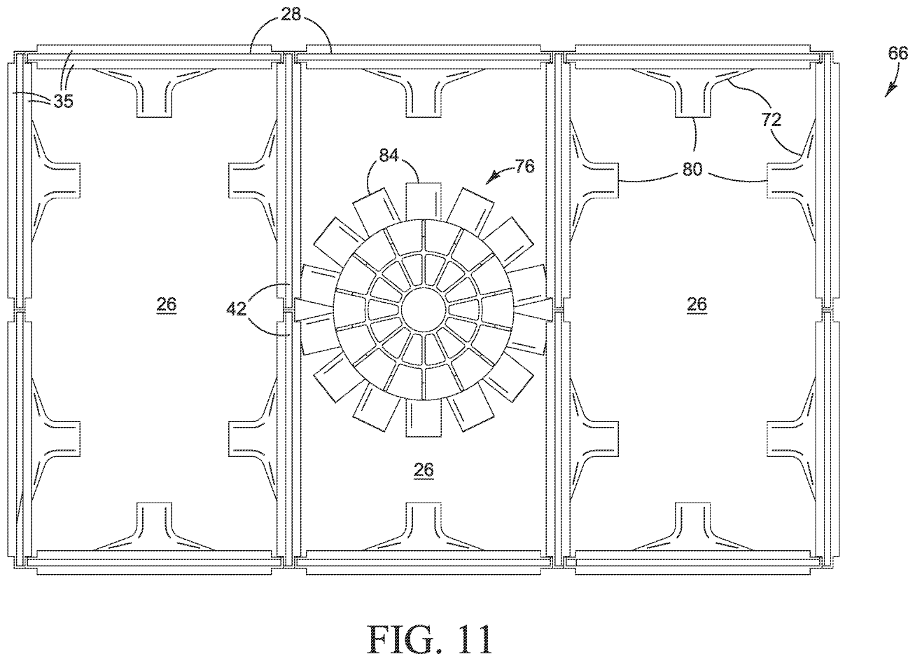

FIGS. 6-11 illustrate an example exhaust hood 16 such as might be used in a printer 46 shown in FIG. 5. FIGS. 6 and 7 are bottom isometric views of hood 16. Hood 16 is partially exploded in FIG. 7. FIGS. 8 and 9 are top isometric views of hood 16. Hood 16 is partially exploded in FIG. 9. FIG. 10 is a top plan view of the interior of hood 16 showing one example for the layout of the flow channel conduits. FIG. 11 is a bottom plan view of hood 16. The flow channel conduits are omitted in FIGS. 6-9 and 11 for clarity to not obscure other features of hood 16. Not all part numbers are repeated for all parts in all of FIGS. 6-11.

Referring first to FIGS. 6-9, exhaust hood 16 includes an enclosure 20 with a base 66 and a cover 68. The outer walls 22 of enclosure base 66 define a rectangular perimeter surrounding the exhaust area. Perimeter intake slots 28 are formed along substantially the full perimeter of enclosure base 66. Crosswise interior intake slots 42 are formed along the interior walls 70 of enclosure base 66. Referring now also to FIGS. 10 and 11, the air flow path 34 through hood 16 includes an intake port 72 connected to each intake slot 28, 42, a conduit 74 connected to each intake port 72, and a central manifold 76 near the top of the enclosure to collect the flows from conduits 74 into a single flow at discharge port 30. Conduits 74 are shown in FIG. 10. Each intake port 72 and corresponding conduit 74 in FIG. 10 along with manifold 76 forms a flow channel 32 between a respective intake slot 28, 42 and discharge port 30.

In this example, each intake port 72 is implemented as a tapered duct integral to a respective wall 22, 70 of enclosure base 66. Thus the walls 22, 70 form a suction frame supporting a cover 68 to contain the vapors while they are sucked out through the frame. Each intake slot 28, 42 forms an inlet to the larger, upstream part 78 of a corresponding intake port 72. Flanges 35 may be formed along each intake slot 28, 42 to strengthen walls 22, 70 and guide air into slots 28, 42. As shown in FIG. 10, each conduit 74 is connected between an outlet 80 from the smaller, downstream part 82 of a corresponding intake port 72 and an inlet 84 on manifold 76. In this example, each intake slot 28 is integral to an intake port 72 and each intake port 72 is integral to a section of wall 22, 42 in a module that provides both structure for enclosure base 66 and a flow path for the exhausted air. A modular configuration such as that shown in FIGS. 6-11 may be desirable, for example, to standardize manufacturing and to more easily adapt an exhaust hood 16 to different size exhaust areas.

In the example shown in FIG. 10, each conduit 74 is implemented as flexible hose for easier routing, for example around and over heat lamps 60 and air knives 62 shown in FIG. 5. A two part enclosure 20 with a separate cover 68 that can be removed provides easier access to interior parts including, for example, heat lamps 60 and air knives 62 shown in FIG. 5. In may be desirable in some implementations to make all conduits 74 the same length for a consistent flow from all intake slots 28, 42. In may be desirable in other implementations to vary the length of conduits 74, for example shorter conduits 74 from perimeter intake slots 28 for a higher flow at the perimeter to help seal against vapor leaking around the hood, without increasing the flow at discharge port 30. Testing and flow simulations indicate tapered intake ports 72, in which the intake flow at each slot 28, 42 is funneled toward an outlet 80 through a narrowing flow channel, promotes uniform flow in a compact space.

Testing and flow simulations also show that, even with comparatively low flows at discharge port 30, a sufficient pressure difference can be generated at perimeter intake slots 28 to seal the perimeter against any significant vapor escaping hood 16 while still evacuating substantially all of the vapor from the exhaust area. For example, a total flow of 46-54 L/s at discharge ports 30 (e.g., 11-14 L/s at each of four ports 30 in FIG. 5) with 4 mm wide intake slots 28, 42 covering about 5.5% of the exhaust area that, together with flow channels 32, generate an intake pressure difference of about 1.8 Pa, will be sufficient to exhaust 120-150 L/s of vapors from a total exhaust area of about 1 m². Due to the lower discharge air flow, e.g. 46-54 L/s/m² compared to more than 1,000 L/s/m² for conventional exhaust hoods, it is easily possible to cool the discharge air to a very low temperature (e.g. −20° C.) to dramatically increase the volume of vapor removed from the discharge air at condenser 64 and thus reduce the concentration of vapor remaining in the air leaving the condenser, for example from 1.5 g/m³ entering the condenser to 0.2 g/m³ leaving the condenser, well below the current regulatory threshold. While the configuration and flow parameters for an exhaust system 10 will vary depending on the particular application, it is expected that, for a typical inline LEP printer, an acceptable level of vapor exhaust can be achieved with a suction flow of 25-100 L/s per square meter (L/s/m²) of exhaust area and a pressure difference of 1.0-3.0 Pa at the intake slots, and with a total intake area less than 10% of the total exhaust area.

As noted above, the examples shown in the figures and described herein illustrate but do not limit the scope of the patent, which is defined in the following Claims.

“A” and “an” in the Claims means one or more. For example, an intake slot means one or more intake slots and subsequent reference to the intake slot means the one or more intake slots.

1. An exhaust hood, comprising:
an enclosure having a perimeter defining an exhaust area; and
a fluid flow path having:
a perimeter intake slot through which air is sucked into the flow path during an exhaust operation, the intake slot extending along substantially the full perimeter of the enclosure such that the perimeter intake slot surrounds the exhaust area; and
a flow channel in fluid communication with the perimeter intake slot and configured to carry fluid away from the intake slot.

2. The exhaust hood of claim 1, wherein:
the perimeter comprises a rectangular perimeter;
the perimeter intake slot comprises multiple perimeter intake slots each extending along a corresponding side of the perimeter; and
the channel comprises multiple conduits each in fluid communication with a corresponding perimeter intake slot.

3. The exhaust hood of claim 2, wherein the channel comprises a manifold having:
multiple inlets each connected to a corresponding conduit; and
a single outlet.

4. The exhaust hood of claim 3, wherein the channel comprises multiple tapered intake ports each having a larger, upstream part and a smaller, downstream part, with each perimeter intake slot forming an inlet to the larger, upstream part of a corresponding intake port and each conduit connected to an outlet from the smaller, downstream part of a corresponding intake port.

5. The exhaust hood of claim 1, wherein:
the perimeter comprises a rectangular perimeter;
the perimeter intake slot comprises multiple perimeter intake slots each extending along a corresponding side of the perimeter;
the flow path comprises an interior intake slot extending across the exhaust area between two of the perimeter intake slots; and
the channel comprises multiple conduits each in fluid communication with a corresponding intake slot.

6. The exhaust hood of claim 5, wherein the channel comprises a manifold having:
multiple inlets each connected to a corresponding conduit; and
a single outlet.

7. The exhaust hood of claim 6, wherein the channel comprises multiple tapered intake ports each having a larger, upstream part and a smaller, downstream part, each intake slot forming an inlet to the larger, upstream part of a corresponding intake port and each conduit connected to an outlet from the smaller, downstream part of a corresponding intake port.

8. The exhaust hood of claim 1, wherein a total intake area of the intake slot is less than 10% of the exhaust area.

9. An exhaust system, comprising:
a hood comprising:
an enclosure having walls defining a rectangular perimeter surrounding an exhaust area;
an intake slot along substantially the full perimeter of the enclosure such that the intake slot surrounds the exhaust area;
a discharge port; and
a flow channel between the intake slot and the discharge port; and
a fan operatively connected to the discharge port and configured to suck air into the intake slot, through the flow channel, and out the discharge port.

10. The exhaust system of claim 9, wherein the flow channel includes an upstream part integral to the walls near the intake slot.

11. The exhaust system of claim 9, comprising a controller programmed to control the fan to generate a suction flow through the discharge port of 25-100 L/s/m² of the exhaust area.

12. The exhaust system of claim 9, comprising a controller programmed to control the fan to generate a pressure difference of 1.0-3.0 Pa at the intake slot with a suction flow at the discharge port of 25-100 L/s/m² of the exhaust area.

13. An exhaust hood, comprising:
an enclosure comprising a base and a removable cover covering the base, the base having walls defining a rectangular perimeter surrounding an exhaust area;
an intake slot along substantially the full perimeter of the enclosure base such that the intake slot surrounds the exhaust area;
a discharge port; and
a flow channel between the intake slot and the discharge port.

14. The exhaust hood of claim 13, wherein:
the intake slot comprises multiple intake slots;
the flow channel comprises multiple intake ports each integral to a wall of the enclosure base; and
each intake slot forms an inlet to a corresponding intake port.

15. The exhaust hood of claim 14, wherein:
the discharge port is a single discharge port; and
the channel includes:
a manifold having multiple inlets and a single outlet to the discharge port; and
multiple flexible hoses each connected between one of the intake ports and one of the manifold inlets.
